(19) United States
(12) Patent Application Publication
(10) Pub. No.: US 2007/0182479 A1
(43) Pub. Date: Aug. 9, 2007

(54) Semiconductor memory device including circuit for blocking operation of bias circuit, and method of generating bias voltage

(75) Inventor: Jun-bae Kim, Seoul (KR)

Correspondence Address: MILLS & ONELLO LLP, ELEVEN BEACON STREET, SUITE 605, BOSTON, MA, 02108, US

(73) Assignee: Samsung Electronics Co., Ltd., Suwon-si (KR)

(21) Appl. No.: 11/704,822

(22) Filed: Feb. 9, 2007

(30) Foreign Application Priority Data
Feb. 9, 2006 (KR) 10-2006-0012581

(51) Int. Cl. G05F 1/10

(52) U.S. Cl. 327/539

(57) ABSTRACT

Provided are a semiconductor memory device comprising a blocking circuit that blocks the operation of a bias circuit, and a method of generating a bias voltage. In the semiconductor memory device, the bias circuit is disabled by using the blocking circuit in a self-refresh mode, and the output terminal of the bias circuit is not electrically floated, but precharged to a specific voltage by a target current supply circuit while the bias circuit is disabled. Accordingly, it is possible to significantly reduce power consumption in the self-refresh mode without affecting the characteristics of analog circuits connected to the output terminal of the bias circuit.

### CROSS-REFERENCE TO RELATED PATENT APPLICATION

This application claims priority under 35 U.S.C. §119 to Korean Patent Application No. 10-2006-0012581, filed on Feb. 9, 2006 in the Korean Intellectual Property Office, the disclosure of which is incorporated herein in its entirety by reference.

### BACKGROUND OF THE INVENTION

1. Field of the Invention

The present invention relates to a semiconductor memory device, and more particularly, to a semiconductor memory device having a circuit that blocks the operation of a bias circuit and a method of generating a bias voltage.

2. Description of the Related Art

As illustrated in FIG. 1, a semiconductor memory device 100, such as a dynamic random access memory (DRAM), includes various analog circuits 13 and 15 that use a bias voltage VBIAS. A delay locked loop (DLL) circuit is a representative analog circuit included in a semiconductor memory device. The bias voltage VBIAS is generated by a bias circuit 11 such as a bandgap reference circuit, known in the art.

As digital circuits operate with low power consumption, much attention has been paid to operating semiconductor memory devices with low power consumption. In particular, in a self-refresh mode of a semiconductor memory device, the bias circuit 11 is the main consumer of power. Thus, to reduce power consumption, i.e., consumption of self-refresh current in the self-refresh mode of a semiconductor device, the bias circuit 11 must be turned off to minimize consumption of bias current. An example of a method of reducing bias current is disclosed in U.S. Pat. No. 5,959,471.

However, when the bias circuit 11 is turned off, the output terminal of the bias circuit 11 connected to input terminals of the analog circuits 13 and 15 can be electrically floated to cause malfunctions of the analog circuits 13 and 15. Thus, the bias circuit 11 is not generally turned off.

### SUMMARY OF THE INVENTION

In accordance with aspects of the present invention, provided is a semiconductor memory device with a circuit that blocks the operation of a bias circuit to minimize power consumption in a self-refresh mode without affecting the characteristics of analog circuits.

In accordance with other aspects of the present invention, also provided is a method of generating a bias voltage while minimizing power consumption in a self-refresh mode without affecting the characteristics of analog circuits.

According to an aspect of the present invention, there is provided a semiconductor memory device with at least one analog circuit, the semiconductor device comprising a bias circuit configured to generate a bias voltage and to supply the bias voltage to the analog circuit; a blocking circuit configured to block the operation of the bias circuit in a self-refresh mode of the semiconductor memory device; and a target current supply circuit configured to supply a target current to an output terminal of the bias circuit while the blocking circuit blocks the operation of the bias circuit.

The blocking circuit can be configured to disable the bias circuit in response to a control signal indicating the self-refresh mode.

The bias circuit can comprise a constant voltage generating circuit configured to generate a constant voltage regardless of a temperature change; a start-up current generating circuit configured to generate a start-up current and to enable the start-up current to flow through a constant voltage node of the constant voltage generating circuit; and a bias voltage generating circuit configured to generate a bias current by mirroring a current generated in the constant voltage generating circuit, and to generate the bias voltage from the bias current.

The blocking circuit can comprise a transistor configured to be controlled by a control signal indicating the self-refresh mode.

The target current supply circuit can include a resistor, one end of which is connected to a supply voltage source, and a switch connected between the other end of the resistor and the output terminal of the bias circuit, the switch configured to be turned on when the operation of the bias circuit is blocked.

The switch can be configured to be closed when the operation of the bias circuit is blocked.

The semiconductor memory device can be a dynamic random access memory (DRAM).

According to another aspect of the present invention, there is provided a method of generating a bias voltage in a semiconductor memory device with at least one analog circuit, the method including generating the bias voltage and supplying the bias voltage to the at least one analog circuit in a normal operation mode of the semiconductor memory device, blocking the generation of the bias voltage in a self-refresh mode of the semiconductor memory device, and supplying a target current to an input terminal of the analog circuit when the generation of the bias voltage is blocked.

The blocking can include disabling a bias circuit, which generates the bias voltage, in response to a control signal indicating the self-refresh mode.

Generating the bias voltage can comprise generating a constant voltage at a constant voltage node, regardless of a temperature change; generating a start-up current and enabling the start-up current to flow through the constant voltage node; and generating a bias current by mirroring a current generated from the constant voltage node, and generating the bias voltage from the bias current.

Blocking the generation of the bias voltage can be performed by a blocking circuit that comprises a transistor and the method comprises controlling the transistor with a control signal indicating the self-refresh mode.

Supplying the target current can comprise providing a target current circuit including a resistor, one end of which is connected to a supply voltage source; and a switch connected between the other end of the resistor and the output terminal of the bias circuit; and turning on the switch when blocking the generation of the bias voltage.

Turning on the switch can include closing the switch when blocking the generation of the bias voltage.

The semiconductor memory device can be a dynamic random access memory (DRAM).

In accordance with another aspect of the invention, there is provided a semiconductor memory device with at least one analog circuit. The semiconductor memory device comprising: a bias circuit configured to generate a bias voltage and to supply the bias voltage to the at least one analog circuit; a blocking circuit configured to block the operation of the bias circuit in a self-refresh mode of the semiconductor memory device, wherein the blocking circuit is configured to disable the bias circuit in response to a control signal indicating the self-refresh mode; and a target current supply circuit configured to supply a target current to an output terminal of the bias circuit while the blocking circuit blocks the operation of the bias circuit. The target current supply circuit comprises a resistor, one end of which is connected to a supply voltage source; and a switch connected between the other end of the resistor and the output terminal of the bias circuit, the switch configured to be turned on when the operation of the bias circuit is blocked.

The semiconductor memory device can be a dynamic random access memory (DRAM).

### BRIEF DESCRIPTION OF THE DRAWINGS

The drawing figures depict exemplary embodiments by way of example, not by way of limitation, in which:

FIG. 1 illustrates a block diagram illustrating connection of a bias circuit to analog circuits in a prior art semiconductor memory device;

FIG. 2 illustrates a block diagram of an embodiment of a semiconductor memory device according to aspects of the present invention;

FIG. 3 illustrates a circuit diagram of embodiments of a bias circuit, a blocking circuit, and a target current supply circuit of the semiconductor memory device illustrated in FIG. 2; and

FIG. 4 illustrates a waveform diagram of a control signal CPMIRR and a constant voltage PMIRR of the semiconductor memory device illustrated in FIG. 2 that are generated in a self-refresh mode.

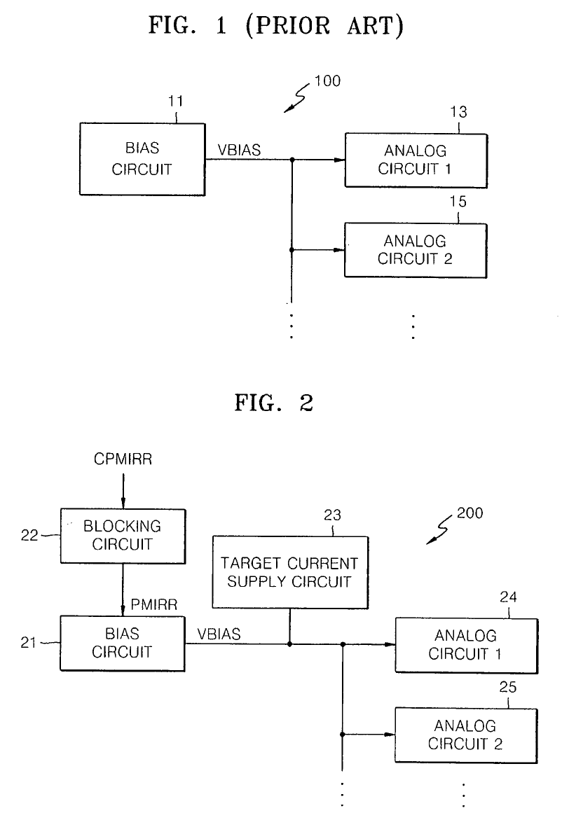

### DETAILED DESCRIPTION OF PREFERRED EMBODIMENTS

Hereinafter, exemplary embodiments disclosing aspects of the present invention will be described in detail with reference to the accompanying drawings. However, the present invention is not limited to the embodiments disclosed herein. Like reference numerals denote like elements throughout the drawings.

It will be understood that, although the terms first, second, etc. may be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

It will be understood that when an element is referred to as being “on” or “connected” or “coupled” to another element, it can be directly on or connected or coupled to the other element or intervening elements may be present. In contrast, when an element is referred to as being “directly on” or “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

FIG. 2 is a block diagram of an embodiment of a semiconductor memory device according to aspects of the present invention. For convenience of explanation, only circuits related to aspects of the present invention are illustrated in FIG. 2. Referring to FIG. 2, in this embodiment the semiconductor memory device 200 includes a bias circuit 21, a blocking circuit 22 configured to block the operation of the bias circuit 21, a target current supply circuit 23, and one or more analog circuits 24 and 25. The semiconductor memory device 200 is configured to generate a bias voltage VBIAS using a method of generating the bias voltage that is in accordance with aspects of the present invention.

The bias circuit 21 generates a bias voltage VBIAS and supplies the bias voltage to the analog circuits 24 and 25 in a normal operation mode of the semiconductor memory device 200. The bias circuit 21 generates a specific reference voltage, wherein a bandgap reference circuit can be used as the bias circuit 21, as an example.

The blocking circuit 22 blocks the operation of the bias circuit 21 in a self-refresh mode of the semiconductor memory device 200. That is, the blocking circuit 22 disables the bias circuit 21 in response to a control signal CPMIRR, indicating transition to or operation in the self-refresh mode of the semiconductor memory device 200.

The target current supply circuit 23 supplies target current to an output terminal of the bias circuit 21 while the blocking circuit 22 blocks the operation of the bias circuit 21. In other words, the target current supply circuit 23 supplies the target current to input terminals of the analog circuits 24 and 25 while the operation of the bias circuit 21 is blocked.

The analog circuits 24 and 25 perform specific analog operations by using the bias voltage VBIAS as a reference voltage, wherein a delay locked loop (DLL) circuit can be used as a representative type of analog circuit included in a semiconductor memory device as analog circuits 25 and 25.

More specifically, conventionally, even if the analog circuits 24 and 25, such as a DLL, do not operate in the self-refresh mode, the bias circuit 21 is continuously operating, thus consuming power. In contrast, in a semiconductor memory device according to the present embodiment, when the control signal CPMIRR is activated in the self-refresh mode, the blocking circuit 22 activates a signal PMIRR to disable (or turn off) the bias circuit 21.

However, when the bias circuit 21 is disabled, the output terminal of the bias circuit 21 is electrically floated to cause the bias voltage VBIAS to have an indefinite value. To prevent this problem, in the present embodiment, while the bias circuit 21 is disabled, the target current supply circuit 23 supplies the target current to the output terminal of the bias circuit 21. Therefore, the output terminal of the bias circuit 21 is precharged to a specific voltage.

Accordingly, the output terminal of the bias circuit 21 can be precharged such that the difference between the bias voltage VBIAS when the bias circuit 21 operates and the bias voltage VBIAS when the bias circuit 21 is disabled is less than about 10%, preferably. Although, in some cases, higher percentages may be allowable. In this case, since the output terminal of the bias circuit 21 has been precharged, when the self-refresh mode ends, the bias circuit 21 adjusts the bias voltage VBIAS to a desired level in a short period of time.

As described above, in the semiconductor memory device 200, the bias circuit 21 is disabled in the self-refresh mode, thereby significantly reducing power consumption. Also, while the bias circuit 21 is disabled, the output terminal of the bias circuit 21 is not electrically floated, but is precharged to a specific voltage by the target current supply circuit 23. Therefore, the characteristics of the analog circuits 24 and 25 do not substantially change.

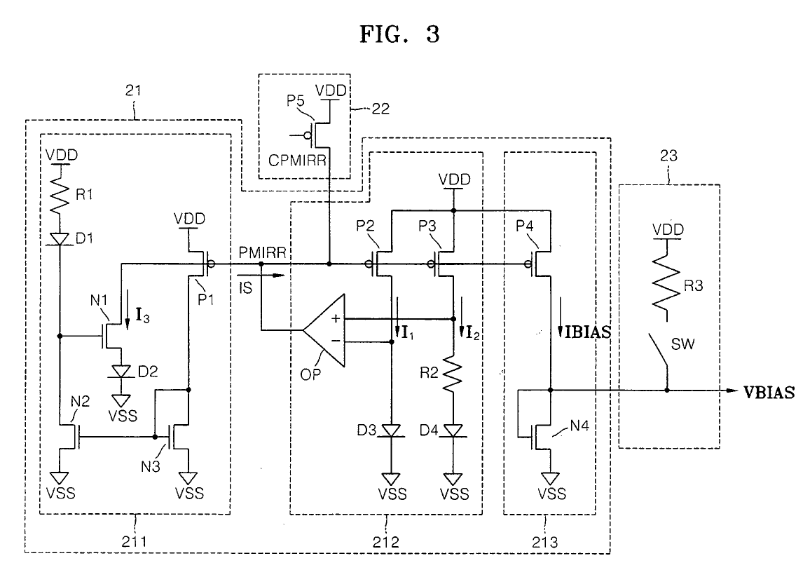

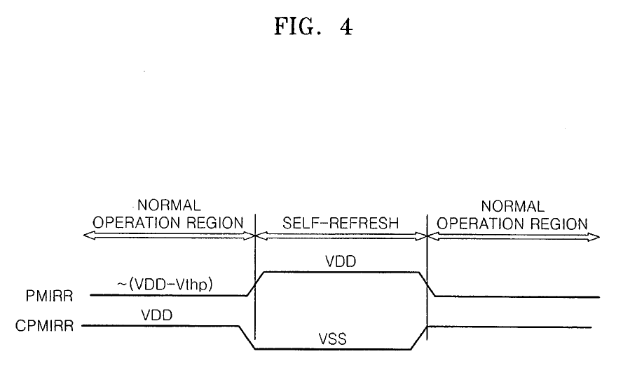

FIG. 3 is a circuit diagram showing embodiments of the bias circuit 21, the blocking circuit 22, and the target current supply circuit 23 of the semiconductor memory device 200 illustrated in FIG. 2. FIG. 4 is a waveform diagram of the control signal CPMIRR and a constant voltage PMIRR that can be generated in the self-refresh mode by the semiconductor device 200 illustrated in FIG. 2.

Referring to FIG. 3, the embodiment of the bias circuit 21 includes a start-up current generating circuit 211 that is a type of a bandgap reference circuit, a constant voltage generating circuit 212, and a bias voltage generating circuit 213.

The embodiment of the start-up current generating circuit 211, which generates a start-up current IS, includes a resistor R1, diodes D1 and D2, a PMOS transistor P1, and NMOS transistors N1 through N3.

The embodiment of the constant voltage generating circuit 212, which generates the substantially constant voltage PMIRR regardless of a temperature change, includes PMOS transistors P2 and P3, a resistor R2, diodes D3 and D4, and an operation amplifier OP. The current I1 flowing through the PMOS transistor P2 is substantially equal to current I2 flowing through the PMOS transistor P3. A constant voltage node PMIRR is connected to the start-up current generating circuit 211, and the start-up current IS flows through the constant voltage node PMIRR.

The bias voltage generating circuit 213 mirrors the current I2 generated in the constant voltage generating circuit 212 to generate bias current IBIAS, and generates the bias voltage VBIAS from the bias current IBIAS. The embodiment of the bias voltage generating circuit 213 includes a PMOS transistor P4 and an NMOS transistor N4.

The bias circuit 21 is generally known to those of ordinary skill in the art, so a detailed description of the operation thereof will be omitted. Also, it would be apparent to those of ordinary skill in the art that the bias circuit 21 can be variously constructed, and need not be limited to the embodiment disclosed herein.

The embodiment of the blocking circuit 22 includes a PMOS transistor P5 having a source to which supply voltage VDD is applied, a drain connected to the constant signal node PMIRR, and a source to which the control signal CPMIRR indicating a self-refresh mode is applied.

The embodiment of the target current supply circuit 23 includes a resistor R3 and a switch SW. One end of the resistor R3 is connected to the supply voltage source VDD. The switch SW is connected between the other end of the resistor R3 and to the output terminal of the bias circuit 21 from which the bias voltage VBIAS is output. The switch is turned on (i.e., closed) when the bias circuit 21 is disabled.

Referring to FIG. 4, in the self-refresh mode, when the control signal CPMIRR is activated low, the PMOS transistor P5 is turned on to correspond to the level of the constant voltage signal PMIRR with the level of the supply voltage VDD. Thus, the PMOS transistors P2 and P3 in the constant voltage generating circuit 212 and the PMOS transistor P4 in the bias voltage generating circuit 213 are turned off to disable the bias circuit 21. In a normal mode, the control signal CPMIRR is activated high to turn off the PMOS transistor P5, and thus, the bias circuit 21 operates normally.

Thus, while the bias circuit 21 is disabled, current is supplied to the bias circuit 21 from the supply voltage source VDD via the resistor R3 and the switch SW, thereby precharging the output terminal of the bias circuit 21 to a specific voltage.

As described above, with the semiconductor memory device and the method of generating a bias voltage according to the present invention, it is possible to reduce power consumption in the self-refresh mode without affecting the characteristics of analog circuits.

While the foregoing has described what are considered to be exemplary embodiments, it will be understood by those of ordinary skill in the art that various changes in form and detail can be made therein without departing from the spirit and scope of the present invention as defined by the following claims. It is intended by the following claims to claim that which is literally described and all equivalents thereto, including all modifications and variations that fall within the scope of each claim.

What is claimed is:

1. A semiconductor memory device with at least one analog circuit, comprising:
a bias circuit configured to generate a bias voltage and to supply the bias voltage to the at least one analog circuit;
a blocking circuit configured to block the operation of the bias circuit in a self-refresh mode of the semiconductor memory device; and
a target current supply circuit configured to supply a target current to an output terminal of the bias circuit while the blocking circuit blocks the operation of the bias circuit.

2. The semiconductor memory device of claim 1, wherein the blocking circuit is configured to disable the bias circuit in response to a control signal indicating the self-refresh mode.

3. The semiconductor memory device of claim 1, wherein the bias circuit comprises:
a constant voltage generating circuit configured to generate a constant voltage regardless of a temperature change;
a start-up current generating circuit configured to generate a start-up current and to enable the start-up current to flow through a constant voltage node of the constant voltage generating circuit; and
a bias voltage generating circuit configured to generate a bias current by mirroring a current generated in the constant voltage generating circuit, and to generate the bias voltage from the bias current.

4. The semiconductor memory device of claim 1, wherein the blocking circuit comprises a transistor configured to be controlled by a control signal indicating the self-refresh mode.

5. The semiconductor memory device of claim 1, wherein the target current supply circuit comprises:
a resistor, one end of which is connected to a supply voltage source; and
a switch connected between the other end of the resistor and the output terminal of the bias circuit, the switch configured to be turned on when the operation of the bias circuit is blocked.

6. The semiconductor memory device of claim 5, wherein the switch is configured to be closed when the operation of the bias circuit is blocked.

7. The semiconductor memory device of claim 1, wherein the device is a dynamic random access memory (DRAM).

8. A method of generating a bias voltage in a semiconductor memory device with at least one analog circuit, the method comprising:
generating the bias voltage and supplying the bias voltage to the at least one analog circuit in a normal operation mode of the semiconductor memory device;
blocking the generation of the bias voltage in a self-refresh mode of the semiconductor memory device; and
supplying a target current to an input terminal of the analog circuit when the generation of the bias voltage is blocked.

9. The method of claim 8, wherein blocking the generation of the bias voltage includes disabling a bias circuit, which generates the bias voltage, in response to a control signal indicating the self-refresh mode.

10. The method of claim 8, wherein generating the bias voltage comprises:
generating a constant voltage at a constant voltage node;
generating a start-up current and enabling the start-up current to flow through the constant voltage node;
generating a bias current by mirroring a current generated from the constant voltage node; and
generating the bias voltage from the bias current.

11. The method of claim 8, wherein blocking the generation of the bias voltage is performed by a blocking circuit that comprises a transistor and the method comprises controlling the transistor with a control signal indicating the self-refresh mode.

12. The method of claim 8, wherein supplying the target current comprises:
providing a target current circuit comprising:
a resistor, one end of which is connected to a supply voltage source; and
a switch connected between the other end of the resistor and the output terminal of the bias circuit; and
turning on the switch when blocking the generation of the bias voltage.

13. The method of claim 12, wherein turning on the switch includes closing the switch when blocking the generation of the bias voltage.

14. The method of claim 8, wherein the semiconductor memory device is a dynamic random access memory (DRAM).

15. A semiconductor memory device with at least one analog circuit, comprising:
a bias circuit configured to generate a bias voltage and to supply the bias voltage to the at least one analog circuit;
a blocking circuit configured to block the operation of the bias circuit in a self-refresh mode of the semiconductor memory device, wherein the blocking circuit is configured to disable the bias circuit in response to a control signal indicating the self-refresh mode; and
a target current supply circuit configured to supply a target current to an output terminal of the bias circuit while the blocking circuit blocks the operation of the bias circuit, the target current supply circuit comprising:
a resistor, one end of which is connected to a supply voltage source; and
a switch connected between the other end of the resistor and the output terminal of the bias circuit, the switch configured to be turned on when the operation of the bias circuit is blocked.

16. The semiconductor memory device of claim 15, wherein the device is a dynamic random access memory (DRAM).
